(19) United States
(12) Patent Application Publication
(10) Pub. No.: US 2008/0046914 A1
(43) Pub. Date: Feb. 21, 2008

(54) NON-VIEWABLE SERVICE IDENTIFICATION FOR AN INTERACTIVE PROGRAM GUIDE

(76) Inventor: Srinivas Gummadi, Alpharetta, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/461,462

(22) Filed: Aug. 1, 2006

(51) Int. Cl. H04N 5/445; G06F 3/00; H04N 7/16; G06F 13/00

(52) U.S. Cl. 725/25; 725/135; 725/52; 725/61; 725/28

(57) ABSTRACT

The present invention is directed towards enabling systems and methods for providing an identifier that displays which channels are not viewable according to a services package authorization. More specifically, a digital host communications terminal (DHCT) receives a package authorization and stores the authorization in memory. Upon display of an interactive program guide (IPG), a processor retrieves the authorization from memory and updates the IPG. The IPG then identifies which channels are not authorized, and subsequently not viewable, by placing an identifier next to each non-authorized, or non-viewable, channel. In this manner, the subscriber knows which channels are not viewable by the IPG as opposed to selecting a non-authorized channel and receiving a message displayed indicating the selected channel is not viewable.

### TECHNICAL FIELD

The present invention is generally related to a communications system and, more particularly, is related to channel identification for an interactive program guide.

### BACKGROUND OF THE INVENTION

Currently, service providers present all of the available services to each of the subscribers, regardless of whether or not any of them actually subscribe to the available services. Therefore, a subscriber's interactive program guide (IPG) displays all of the services on different channels that a service provider has available to all subscribers. A subscriber can view the IPG and select a program from one of the channels to view, record, or purchase. However, it may be unclear to the subscriber which services are included with their subscribed package and which services are not. The subscriber needs to select a channel, and if they are not authorized for the service on that channel, a black screen with a caption directs them to call the service provider to subscribe for that selected service. There is a need, therefore, for systems and methods that indicate to a subscriber which services they are authorized to view without having to actually select the channel.

### BRIEF DESCRIPTION OF THE DRAWINGS

The invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a digital broadband delivery system (DBDS) that provides services to a plurality of digital host communication terminals (DHCTs).

FIG. 2 is an example of an abridged transport stream including a DHCT address; package, or service, authorization; and streamed services.

FIG. 3 is an example of an abridged IPG that is suitable for use in the DBDS of FIG. 1.

FIG. 4 is an example message displayed when a subscriber selects a non-viewable service of the IPG of FIG. 3.

FIG. 5 is an example of an abridged IPG, which identifies non-viewable channels, that is suitable for use in the DBDS of FIG. 1.

FIG. 6 is a block diagram of a DHCT in accordance with the present invention coupled to a display.

FIG. 7 is an illustration of tables displaying authorized channels and associated services according to a received service package authorization.

### DETAILED DESCRIPTION OF THE PREFERRED EMBODIMENTS

The preferred embodiments of the invention now will be described more fully hereinafter with reference to the accompanying drawings, in which preferred embodiments of the invention are shown. The invention may, however, be embodied in many different forms and should not be construed as limited to the embodiments set forth herein; rather, these embodiments are provided so that this disclosure will be thorough and complete, and will fully convey the scope of the invention to those skilled in the art. Furthermore, all “examples” given herein are intended to be non-limiting.

The present invention is directed towards the enablement of allowing a subscriber to view an interactive program guide (IPG) that clearly displays which services are not included in their authorized package. More specifically, the IPG includes identification for non-authorized, or non-viewable, services on certain channels. In this manner, a subscriber easily determines which services are viewable and which services are not viewable while browsing and remaining in the IPG without having to select a channel, which displays a non-authorized barker.

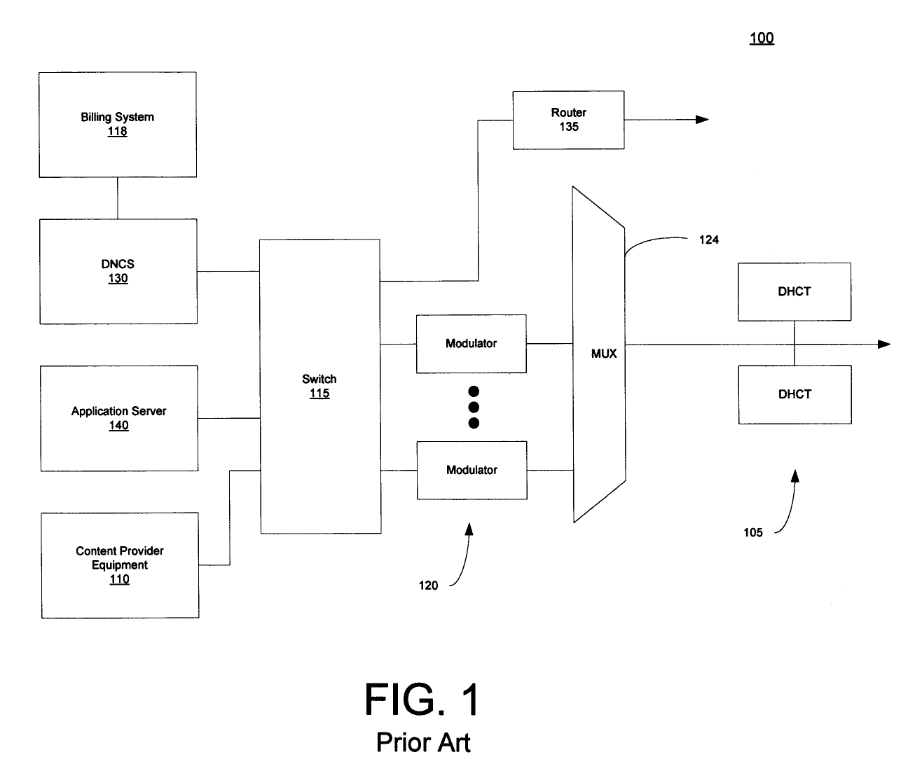

FIG. 1 is a block diagram of a digital broadband delivery system (DBDS) 100 that provides services to a plurality of digital host communication terminals (DHCTs) 105. Briefly, different services each including a plurality of programs is received via content provider equipment 110 from multiple source providers. Among many functions, the content provider equipment 110 prepares the services and forwards them to a switch 115. The switch 115 typically routes the services to a plurality of modulators 120 for delivery, but may also route the services to a router 135 for delivery over Ethernet IP depending upon the application. The modulators 120 modulate the services into a data channel that typically transmits eight or more digital services, and the transmitted data is subsequently combined via a multiplexer 124. The combined stream is then broadcasted to the plurality of DHCTs 105. Since the combined stream is broadcasted to all of the DHCTs 105, the DHCTs 105 are given authorization codes via a billing system 118 to decrypt certain services depending upon their subscription status.

Also included in the DBDS 100 is a digital network control system (DNCS) 130 that controls all the DBDS devices in the system 100. Data is typically entered into the DNCS 130 by a system operator. For example, based on information entered into the DNCS 130, the modulators 120 generate packets containing MPEG-2 program-specific information and system information. The modulators 120 then insert this information into the outgoing transport stream. Additionally, the DNCS 130 retrieves IPG data for each service from an application server 140. The application server 140 normally receives IPG data, which includes program names, times, and dates, from an IPG vendor 145. After retrieving the IPG data, the application server 140 decompresses the file and places the data in a database for access by the DNCS 130. The IPG data is then typically provided in-band along with the streamed services and data as well as out-of-band directly to an IPG client application that is resident on the DHCT 105. It will be appreciated that the IPG lists upcoming and current programs for each service. Additional functions of the DNCS 130 include provisioning the received services. Some services, like FOX Sports World (FOXSW), may be offered to all subscribers and broadcasted in the clear or they may be encrypted and offered as a subscription-based channel. Each service is then assigned a channel on a channel map. Subscribers can then choose a service, such as FOXSW, by selecting its associated channel either by tuning to the channel or by selecting it from the IPG.

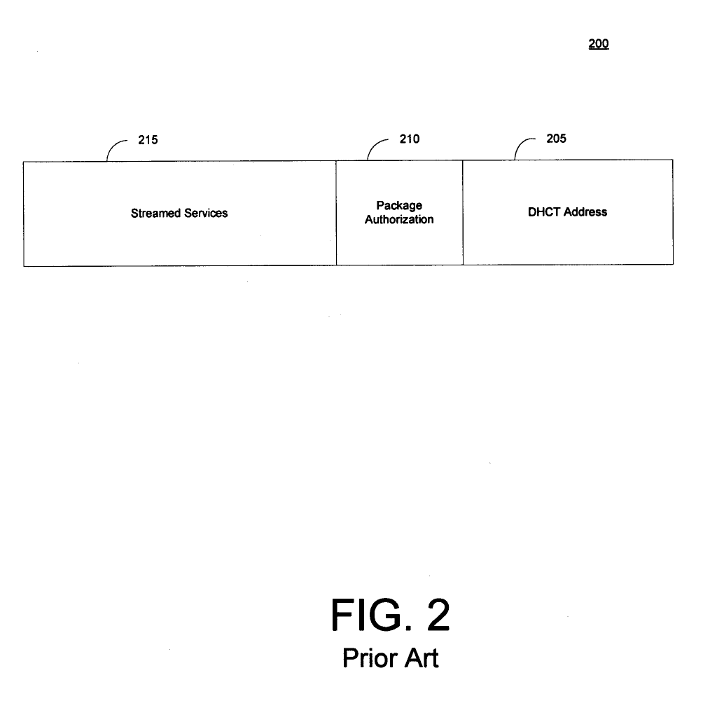

FIG. 2 is an example of an abridged transport stream 200 including a DHCT address 205; package, or service, authorization 210; and streamed services 215. A DHCT 105 recognizes its address and accepts the package authorization. From the package authorization, the DHCT 105 then knows which services can be displayed and which services cannot.

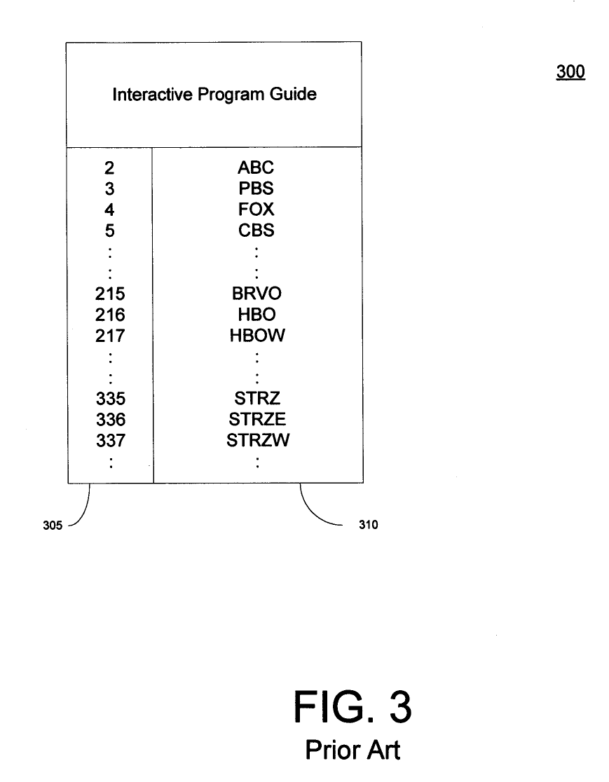

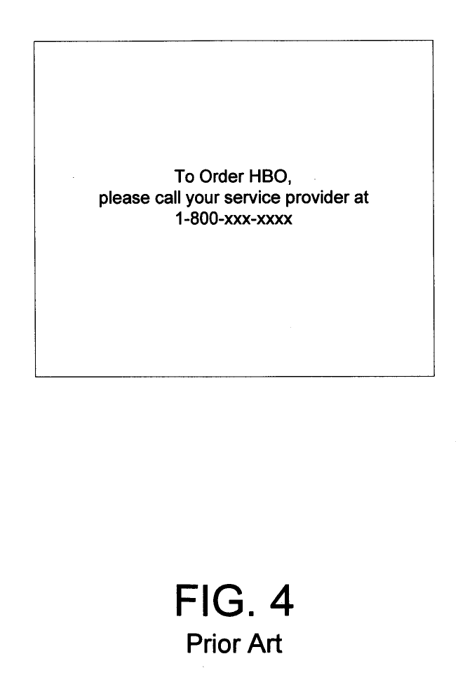

FIG. 3 is an example of an abridged IPG that is suitable for use in the DBDS of FIG. 1. A subscriber may select to view the IPG 300 by selecting a “guide” button on a remote control, for example. The IPG 300 subsequently displays all of the channels 305 along with its associated service abbreviation 310. The DHCT 105 receives its package, or services, authorization upon boot-up of the DHCT 105 or at any time there are changes to the authorization. Therefore, a subscriber can then select a channel, for example, channel 2, and the DHCT 105 tunes to an appropriate frequency to filter and display that channel. By way of example, a subscriber for one DHCT 105 may have selected a basic service package; therefore, the DNCS 130 sends a package authorization limiting the viewable services. In this example, however, when the subscriber selects channel 216 to watch the HBO service, the IPG 300 tunes to channel 216 and displays the illustration of FIG. 4. Disadvantageously, the subscriber did not recognize from the IPG 300 that the DHCT 105 is not authorized to decrypt channel 216 based on its current service package authorization.

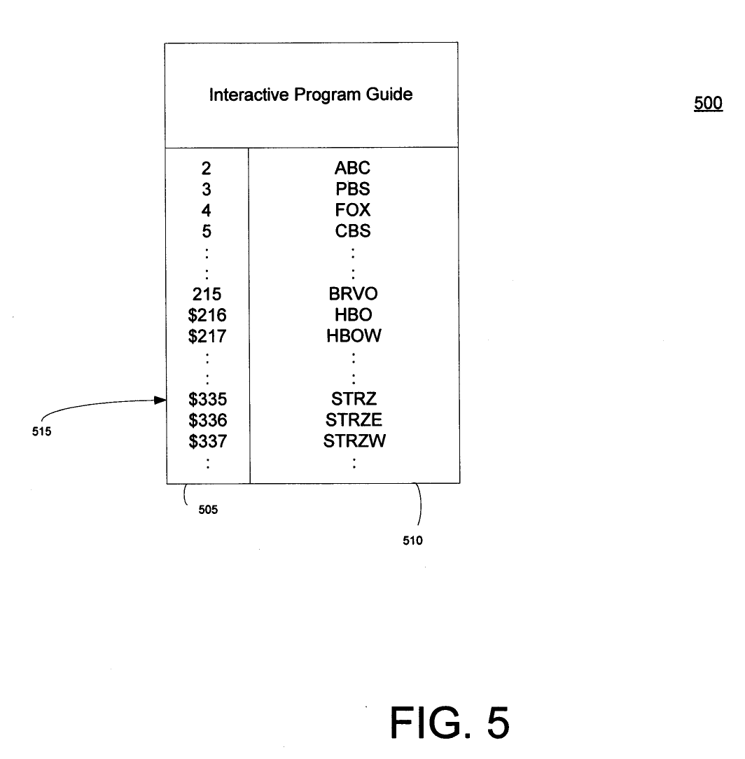

In accordance with the present invention, FIG. 5 is an example of an abridged IPG according to the present invention, which identifies non-viewable channels, that is suitable for use in the DBDS of FIG. 1. Again, a subscriber may select to view the IPG 500 by selecting a “guide” button on a remote control. The IPG 500 subsequently displays all of the channels 505 along with its associated service abbreviation 510. According to the DHCT's service package authorization, the IPG 500 identifies which services and channels are viewable and which services and channels are non-viewable. An identifier (e.g., $) 515 is displayed in association with or alongside the channel number and associated service indicating to the subscriber that these channels are not currently in their authorized services package; therefore, they are non-viewable. Advantageously, a subscriber knows which channels are not viewable without having to select the channel and receive a display indication.

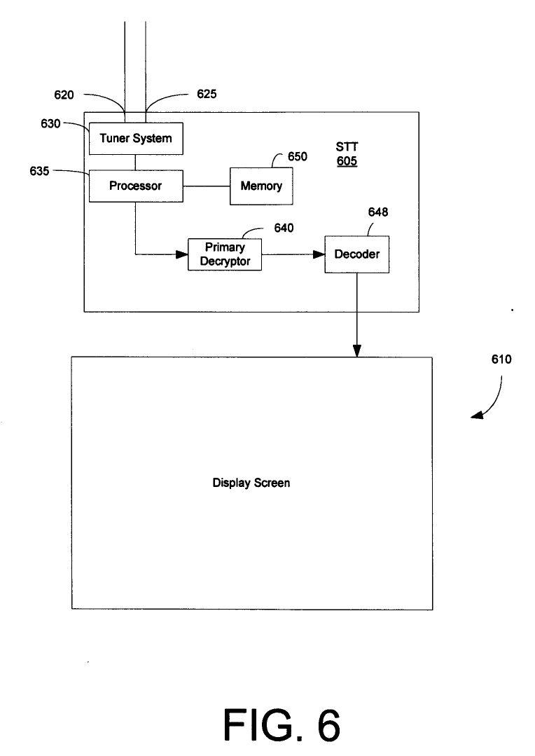

FIG. 6 is a block diagram of a DHCT 605 in accordance with the present invention coupled to a display 610. A tuner system 630 receives a broadcasted stream from an in-band port 620. Similarly, the tuner system 630 receives out-of-band signals, such as an updated IPG or a services package authorization, from an out-of-band port 625. A processor 635 receives and processes the incoming signals according to their function. For example, if a subscriber wishes to watch television and selects a channel, the tuner system 630 filters that channel and provides the service to the processor 635. As necessary, a decryptor 640 decrypts the service, if encrypted, and a decoder 648 prepares the signal for viewing on the display 610 in a known manner. If a service package authorization is received, the processor 635 forwards a copy of the authorization to memory 650 for use in the IPG 500 in accordance with the present invention.

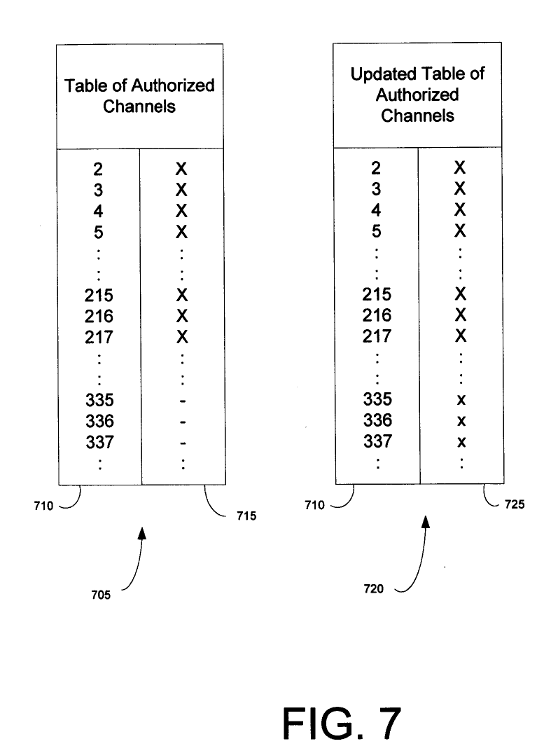

FIG. 7 is an illustration of tables displaying authorized channels and associated services according to a received service package authorization. When the processor 635 receives a service package authorization, it is stored in memory 650 as table 705. A list 710 of all available channels is displayed along with an authorized column 715 indicating which channels 705 the DHCT 605 is authorized or not authorized to view. Subsequently, upon presenting an IPG 500, the processor 635 retrieves the authorized channel table and indicates which channel, or services, are not included in the subscribed service package, as shown in FIG. 5. An updated table 720 of authorized channels is also shown in FIG. 7. When an update is received, the authorized column 725 is updated to include any changes made to the subscriber's service package. For example, the DHCT 605 is now authorized to also present channels 335, 336, and 337, which were previously not authorized for viewing. The previous table 705 is replaced with the updated table 720 and, when the IPG 500 is requested, the processor 635 retrieves the updated table 720 and identifies any channels that are not currently authorized in the service package. It will be appreciated that the processor 635 can update the table of authorized channels at the time the DHCT 605 powers or when a change to the package authorization is received from the service provider.

Accordingly, systems and methods have been described that enable a subscriber to know which channels, or services, are available for viewing by identifying the channels in an IPG. It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and protected by the following claims.

1. A method of presenting an interactive program guide (IPG), the method comprising the steps of:
populating an IPG with program information for each channel, wherein the channel is one of an authorized or a non-authorized channel;
inserting an identifier next to each non-authorized channel based on a service package authorization; and
presenting the IPG including the identifiers.

2. The method of claim 1, further comprising the step of receiving the service package authorization from a service provider.

3. The method of claim 1, further comprising the step of retrieving the service package authorization from memory, wherein the service package authorization specifies authorized and non-authorized channels.

4. The method of claim 3, further comprising the steps of:
updating the service package authorization in memory with an updated service package authorization; and
inserting the identifier next to each non-authorized channel based on the updated service package authorization.

5. The method of claim 4, further comprising the step of receiving the updated service package authorization from a service provider.

6. The method of claim 1, wherein each channel can be selected, wherein when a channel is selected from the IPG, authorized channels are displayed and non-authorized channels having an identifier display a message display.

7. The method of claim 1, further comprising the steps of:
receiving the service package authorization from a service provider; and
storing the service package authorization in memory.

8. A DHCT for generating and presenting an IPG, comprising:
a processor for receiving IPG data and a service package authorization, wherein the service package authorization specifies authorized and non-authorized channels,
wherein the processor populates an IPG client application with the IPG data and an identifier for identifying non-authorized channels on an IPG, and wherein the IPG is presented to a display device.

9. The DHCT of claim 8, further comprising memory for storing the service package authorization, wherein when an updated service package authorization is received by the DHCT to replace the stored service package authorization with the updated service package authorization for use in the IPG client application.

10. The DHCT of claim 8, wherein the displayed IPG includes a list of the authorized and the non-authorized channels, wherein the identifier is displayed alongside each non-authorized channel.

11. A communications system for transmitting services and information, the communications system comprising:
a service provider for providing the services and information, wherein the services are broadcasted and the information is provided to at least one DHCT address;
a plurality of DHCTs for receiving the broadcasted services and selectively receiving the information based on the receiving DHCT address, each DHCT comprising:
an IPG client application for receiving IPG information regarding each broadcasted service; and
a processor for receiving service package authorization information including authorized and non-authorized information for each broadcasted service, and for presenting an IPG including each broadcasted service with an associated identifier for each non-authorized broadcasted service.

12. The communications system of claim 11, the DHCT further comprising memory for storing the service package authorization information in an authorization table.

13. The communications system of claim 12, wherein the authorization table is changed when an updated service package authorization information is received, and wherein the IPG client application updates the IPG to display the identifier for each non-authorized broadcasted service in accordance with the updated service package authorization information.

14. The communications system of claim 11, wherein, when a broadcasted service is selected for viewing from the IPG, authorized broadcasted services are tuned to and displayed and non-authorized broadcasted services having an identifier display a message display and the broadcasted service is non-viewable.

15. A device for providing an IPG listing a plurality of services, the device comprising:
means for providing the IPG with program information for each of the plurality of services, wherein each service is one of an authorized service or a non-authorized service;
means for inserting an identifier next to each non-authorized service based on a service package authorization; and
means for presenting the IPG including the identifiers.

16. The device of claim 15, further comprising:
means for receiving the program information for each of the plurality of services and the service package authorization; and
means for storing the service package authorization,
wherein when the service package authorization is updated, the updated service package authorization replaces the previously stored service package authorization.
